(19) United States
(12) Patent Application Publication
(10) Pub. No.: US 2024/0299960 A1
(43) Pub. Date: Sep. 12, 2024

(54) SHOWERHEAD

(71) Applicant: KOHLER MIRA LIMITED, Cheltenham (GB)

(72) Inventors: Richard Burns, Cheltenham (GB); Benjamin Lea, Cheltenham (GB)

(21) Appl. No.: 18/583,176

(22) Filed: Feb. 21, 2024

(30) Foreign Application Priority Data
Mar. 9, 2023 (GB) 2303489.5

(51) Int. Cl. B05B 1/28; B05B 1/18

(52) U.S. Cl. CPC B05B 1/28; B05B 1/18

(57) ABSTRACT

A showerhead for an overhead shower is provided, and includes a faceplate with one or more apertures, and a chamber within the showerhead. The chamber is in fluid communication with a water supply. A nozzle is also disposed at least partially in each aperture. One or more of the nozzles have a nozzle body with a nozzle inlet at a first end and a nozzle outlet at a second end. The nozzle inlet is inboard of the faceplate. One or more enclosure portions protrude into the chamber from a back plate. A portion of the nozzle body including the nozzle inlet is surrounded at least partially by the enclosure portion. A first gap is between the nozzle body and the enclosure portion. The enclosure portion and the nozzle body together provide a tortuous, relatively narrow flow path.

### CROSS REFERENCE

This application claims priority to UK Application No. 2303489.5, filed Mar. 9, 2023, the entirety which is hereby incorporated by reference.

### FIELD OF THE INVENTION

This application relates to a showerhead, in particular a showerhead for an overhead shower.

### BACKGROUND OF THE INVENTION

After use, residual water can remain in a flow path through a showerhead for an overhead shower, which can, when enough pressure remains from the residual water, result in unwanted dripping of water out of one or more nozzles of the showerhead.

This occurrence may be particularly likely when the nozzles in the showerhead are larger than a typically-used nozzle size. Employing larger nozzles may provide an enhanced shower experience, such as providing alternative shower spray patterns and/or shower spray patterns that may have larger coverage areas and/or higher water throughputs.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a sectional view of a portion of an example showerhead for an overhead shower.

FIG. 2 shows a sectional view of a portion of an example showerhead for an overhead shower.

FIG. 3 shows a sectional view of a portion of a showerhead for an overhead shower.

FIG. 4 illustrates schematically an example ablutionary system comprising an example showerhead.

### DETAILED DESCRIPTION OF THE DRAWINGS

A first aspect provides a showerhead for an overhead shower comprising:
a faceplate with one or more apertures therein;
a chamber disposed within the showerhead, the chamber being configured to be in fluid communication, in use, with a water supply;
a nozzle disposed at least partially in each aperture, one or more of the nozzles comprising a nozzle body having a nozzle inlet at a first end and a nozzle outlet at a second end, wherein the nozzle inlet is inboard of the faceplate;
one or more enclosure portions protruding into the chamber from a back plate, wherein each enclosure portion is configured such that a portion of the nozzle body including the nozzle inlet is surrounded at least partially by the enclosure portion and there is a first gap between the nozzle body and the enclosure portion such that, in use, water can flow from the chamber through the first gap and into the nozzle inlet;
wherein the enclosure portion and the nozzle body together provide a tortuous, relatively narrow flow path from the chamber through the first gap to the nozzle inlet to reduce or prevent dripping of water from the showerhead occurring at any time when the showerhead is not in operation.

The tortuous, relatively narrow flow paths from the chamber to each nozzle inlet may provide a labyrinth that helps to retain water within the showerhead when the showerhead is not in operation, thereby limiting or preventing dripping of water from the showerhead occurring at any time when the showerhead is not in operation. This may also help to enable the use of relatively larger diameter nozzles in the showerhead.

The first gap may be configured such that surface tension of water retained in the first gap when the showerhead is not in operation may be sufficient to limit or prevent dripping of water from occurring at any time when the showerhead is not in operation.

A surface of the nozzle body and/or a surface of the enclosure portion bounding the first gap may be textured and/or roughened. For example, a surface of the nozzle body and/or a surface of the enclosure portion bounding the first gap may have a VDI (Verein Deutscher Ingenieure) 3400 surface finish. As a result of a surface of the nozzle body and/or a surface of the enclosure portion bounding the first gap being textured and/or roughened, surface tension of water retained in the first gap when the showerhead is not in operation may be increased. Accordingly, dripping of water may be less likely to occur at any time when the showerhead is not in operation.

The first gap may have a width of at least 1 mm, at least 2 mm or at least 3 mm. The first gap may have a width of up to 4 mm, up to 5 mm or up to 6 mm.

The first gap may have a length of at least 5 mm or at least 10 mm. The first gap may have a length of up to 12 mm, up to 15 mm, up to 20 mm or up to 30 mm.

A ratio of a width of the first gap to a length of the first gap may be at least 1:2, at least 1:3 or at least 1:4. The ratio of the width of the first gap to the length of the first gap may be up to 1:4, up to 1:5, up to 1:6, up to 1:10 or up to 1:15.

The first gap may have a substantially uniform width along its length. The width of the first gap may be non-uniform along the length of the first gap.

The first gap may have a maximum width of at least 1 mm, at least 2 mm or at least 3 mm. The first gap may have a maximum width of up to 4 mm, up to 5 mm or up to 6 mm.

The first gap may have a maximum length of at least 5 mm or at least 10 mm. The first gap may have a maximum length of up to 12 mm, up to 15 mm, up to 20 mm or up to 30 mm.

A ratio of a maximum width of the first gap to a maximum length of the first gap may be at least 1:2, at least 1:3 or at least 1:4. The ratio of the maximum width of the first gap to the maximum length of the first gap may be up to 1:4, up to 1:5, up to 1:6, up to 1:10 or up to 1:15.

In implementations, the faceplate may have a plurality of apertures therein. Implementations may comprise a plurality of nozzles and a plurality of enclosure portions. The first gaps between the nozzle bodies and the enclosure portions may be substantially uniform in their shape and dimensions or may be non-uniform in their shape and dimensions, i.e. the shape and dimensions of one or more of the first gaps may differ from the shape and dimensions of at least one of the other first gaps.

The chamber may have a height of up to or at least 10 mm, up to or at least 20 mm, up to or at least 30 mm, up to or at least 40 mm, up to or at least 50 mm or up to or at least 60 mm.

The enclosure portion may protrude into the chamber from the back plate by a distance that is at least 40% of the height of the chamber, at least 50% of the height of the chamber, at least 60% of the height of the chamber, at least 70% of the height of the chamber, at least 80% of the height of the chamber or at least 90% of the height of the chamber.

The height of the chamber may be substantially uniform or may be non-uniform.

The chamber may have a maximum height of up to or at least 10 mm, up to or at least 20 mm, up to or at least 30 mm, up to or at least 40 mm, up to or at least 50 mm or up to or at least 60 mm.

The enclosure portion may protrude into the chamber from the back plate by a distance that is at least 40% of the maximum height of the chamber, at least 50% of the maximum height of the chamber, at least 60% of the maximum height of the chamber, at least 70% of the maximum height of the chamber, at least 80% of the maximum height of the chamber or at least 90% of the maximum height of the chamber.

The enclosure portion may protrude into the chamber from the back plate by a distance that is at least 40% of a local height of the chamber, at least 50% of a local height of the chamber, at least 60% of a local height of the chamber, at least 70% of a local height of the chamber, at least 80% of a local height of the chamber or at least 90% of a local height of the chamber.

In implementations comprising a plurality of enclosure portions, the enclosure portions may be substantially uniform in their shape and dimensions or may be non-uniform in their shape and dimensions, i.e. the shape and dimensions of one or more of the enclosure portions may differ from the shape and dimensions of at least one of the other enclosure portions.

In implementations, one of more projection portions may protrude from the back plate. A given projection portion may be disposed inside one of the enclosure portions. In an implementation, a given projection portion and a given enclosure portion may be arranged concentrically with each other. For example, one or more of the projection portions may be cylindrical in form.

The or each projection portion may extend a distance beyond the nozzle inlet into the nozzle body such that, in use, water can flow through a second gap between the projection portion and the nozzle body or a portion thereof after passing through the nozzle inlet. The second gap may provide a relatively narrow flow path within the nozzle body, which may help to reduce or prevent dripping of water from the showerhead occurring at any time when the showerhead is not in operation.

A tortuous, relatively narrow flow path from the chamber to within the nozzle may comprise the first gap and the second gap. The tortuous, relatively narrow flow paths from the chamber to within the nozzles may provide a labyrinth that helps to retain water within the showerhead when the showerhead is not in operation, thereby limiting or preventing dripping of water from the showerhead occurring at any time when the showerhead is not in operation. This may also help to enable the use of relatively larger diameter nozzles in the showerhead.

The second gap may be configured such that surface tension of water retained in the second gap when the showerhead is not in operation may be sufficient to limit or prevent dripping of water from occurring at any time when the showerhead is not in operation.

A surface of the nozzle body and/or a surface of the projection portion bounding the second gap may be textured and/or roughened. For example, a surface of the nozzle body and/or a surface of the projection portion bounding the second gap may have a VDI (Verein Deutscher Ingenieure) 3400 surface finish. As a result of a surface of the nozzle body and/or a surface of the projection portion bounding the second gap being textured and/or roughened, surface tension of water retained in the second gap when the showerhead is not in operation may be increased. Accordingly, dripping of water may be less likely to occur at any time when the showerhead is not in operation.

For example, one or more of the projection portions may be cylindrical in form at least in part.

The second gap may comprise an annular gap between the projection portion and the nozzle body or a portion thereof.

The number of projection portions may be less than the number of enclosure portions. The number of projection portions may be the same as the number of enclosure portions. The number of projection portions may be more than the number of enclosure portions.

For a given tortuous, relatively narrow flow path from the chamber to within a given nozzle, the second gap may have the same width or the same maximum width as the first gap. The second gap may be wider than or narrower than the first gap. The second gap may be shorter than, longer than or have substantially the same length as the first gap.

The second gap may have a width of at least 1 mm, at least 2 mm or at least 3 mm. The second gap may have a width of up to 4 mm, up to 5 mm or up to 6 mm.

The second gap may have a length of at least 5 mm or at least 10 mm. The second gap may have a length of up to 12 mm, up to 15 mm, up to 20 mm or up to 30 mm.

A ratio of a width of the second gap to a length of the second gap may be at least 1:2, at least 1:3 or at least 1:4. The ratio of the width of the second gap to the length of the second gap may be up to 1:4, up to 1:5, up to 1:6, up to 1:10 or up to 1:15.

The second gap may have a substantially uniform width along its length. The width of the second gap may be non-uniform along the length of the second gap.

The second gap may have a maximum width of at least 1 mm, at least 2 mm or at least 3 mm. The second gap may have a maximum width of up to 4 mm, up to 5 mm or up to 6 mm.

The second gap may have a maximum length of at least 5 mm or at least 10 mm. The second gap may have a maximum length of up to 12 mm, up to 15 mm, up to 20 mm or up to 30 mm.

A ratio of a maximum width of the second gap to a maximum length of the second gap may be at least 1:2, at least 1:3 or at least 1:4. The ratio of the maximum width of the second gap to the maximum length of the second gap may be up to 1:4, up to 1:5, up to 1:6, up to 1:10 or up to 1:15.

In implementations, the faceplate may have a plurality of apertures therein. Implementations may comprise a plurality of nozzles and a plurality of projection portions. The second gaps between the nozzle bodies and the projection portions may be substantially uniform in their shape and dimensions or may be non-uniform in their shape and dimensions, i.e. the shape and dimensions of one or more of the second gaps may differ from the shape and dimensions of at least one of the other second gaps.

The projection portion may protrude from the back plate by a distance beyond the nozzle inlet into the nozzle body that is at least 5% or at least 10% of a distance from the nozzle inlet to the nozzle outlet. The projection portion may protrude from the back plate by a distance beyond the nozzle inlet into the nozzle body that is up to 30%, up to 50% or up to 70% of the distance from the nozzle inlet to the nozzle outlet.

In implementations comprising a plurality of projection portions, the projection portions may be substantially uniform in their shape and dimensions or may be non-uniform in their shape and dimensions, i.e. the shape and dimensions of one or more of the projection portions may differ from the shape and dimensions of at least one of the other projection portions.

One or more of the nozzle bodies may comprise a portion of uniform cross-section, e.g. a cylindrical portion. The portion of uniform cross-section may extend from the nozzle inlet.

One or more of the nozzle bodies may comprise a portion of non-uniform cross-section, e.g. a tapered or conical portion. The portion of non-uniform cross-section may lead to the nozzle outlet.

For example, one or more of the nozzle bodies may comprise a portion of uniform cross-section and a portion of non-uniform cross-section. The portion of non-uniform cross-section may be disposed downstream or upstream of the portion of uniform cross-section.

In implementations comprising a plurality of nozzles, the nozzle bodies may be substantially uniform in their shape and dimensions or may be non-uniform in their shape and dimensions, i.e. the shape and dimensions of one or more of the nozzle bodies may differ from the shape and dimensions of at least one of the other nozzle bodies.

One or more of the nozzle bodies may be formed of one or more nozzle body parts. Any given nozzle body may be formed of any number or combination of nozzle body parts.

In implementations comprising a plurality of nozzles, the nozzle bodies may be substantially uniform in their construction or may be non-uniform in their construction, e.g. one or more of the nozzle bodies may be formed of a different number or combination of nozzle body parts from at least one of the other nozzle bodies.

One or more of the nozzles may be formed at least in part from a flexible material, e.g. a flexible polymeric material.

One or more of the nozzles or one or more of the nozzle body portions may be fixed in place by a nozzle fixing plate.

The nozzle fixing plate may be disposed adjacent an inner surface of the faceplate. The nozzle fixing plate may be disposed between the faceplate and the chamber. The chamber may be disposed between the nozzle fixing plate and the back plate.

The faceplate may comprise any number of apertures therein with a nozzle disposed at least partially in each aperture.

A second aspect provides a showerhead for an overhead shower comprising:
a faceplate with one or more apertures therein;
a chamber disposed within the showerhead, the chamber being configured to be in fluid communication, in use, with a water supply;
a nozzle disposed at least partially in each aperture, one or more of the nozzles comprising a nozzle body having a nozzle inlet at a first end and a nozzle outlet at a second end, wherein the nozzle inlet is inboard of the faceplate;
one or more projection portions protruding from a back plate and extending a distance beyond the nozzle inlet into the nozzle body such that, in use, water can glow through a first gap between the projection portion and the nozzle body or a portion thereof after passing through the nozzle inlet;
wherein the first gap provides a relatively narrow flow path within the nozzle body to help reduce or prevent dripping of water from the showerhead occurring at any time when the showerhead is not in operation.

The first gap may be configured such that surface tension of water retained in the first gap when the showerhead is not in operation may be sufficient to limit or prevent dripping of water from occurring at any time when the showerhead is not in operation.

A surface of the nozzle body and/or a surface of the projection portion bounding the first gap may be textured and/or roughened. For example, a surface of the nozzle body and/or a surface of the projection portion bounding the first gap may have a VDI (Verein Deutscher Ingenieure) 3400 surface finish. As a result of a surface of the nozzle body and/or a surface of the projection portion bounding the first gap being textured and/or roughened, surface tension of water retained in the first gap when the showerhead is not in operation may be increased. Accordingly, dripping of water may be less likely to occur at any time when the showerhead is not in operation.

For example, one or more of the projection portions may be cylindrical in form at least in part.

The first gap may comprise an annular gap between the projection portion and the nozzle body or a portion thereof.

The first gap may have a width of at least 1 mm, at least 2 mm or at least 3 mm. The first gap may have a width of up to 4 mm, up to 5 mm or up to 6 mm.

The first gap may have a length of at least 5 mm or at least 10 mm. The first gap may have a length of up to 12 mm, up to 15 mm, up to 20 mm or up to 30 mm.

A ratio of a width of the first gap to a length of the first gap may be at least 1:2, at least 1:3 or at least 1:4. The ratio of the width of the first gap to the length of the first gap may be up to 1:4, up to 1:5, up to 1:6, up to 1:10 or up to 1:15.

The first gap may have a substantially uniform width along its length. The width of the first gap may be non-uniform along the length of the first gap.

The first gap may have a maximum width of at least 1 mm, at least 2 mm or at least 3 mm. The first gap may have a maximum width of up to 4 mm, up to 5 mm or up to 6 mm.

The first gap may have a maximum length of at least 5 mm or at least 10 mm. The first gap may have a maximum length of up to 12 mm, up to 15 mm, up to 20 mm or up to 30 mm.

A ratio of a maximum width of the first gap to a maximum length of the first gap may be at least 1:2, at least 1:3 or at least 1:4. The ratio of the maximum width of the first gap to the maximum length of the first gap may be up to 1:4, up to 1:5, up to 1:6, up to 1:10 or up to 1:15.

In implementations, the faceplate may have a plurality of apertures therein. Implementations may comprise a plurality of nozzles and a plurality of projection portions. The first gaps between the nozzle bodies and the projection portions may be substantially uniform in their shape and dimensions or may be non-uniform in their shape and dimensions, i.e. the shape and dimensions of one or more of the first gaps may differ from the shape and dimensions of at least one of the other first gaps.

The projection portion may protrude from the back plate by a distance beyond the nozzle inlet into the nozzle body that is at least 5% or at least 10% of a distance from the nozzle inlet to the nozzle outlet. The projection portion may protrude from the back plate by a distance beyond the nozzle inlet into the nozzle body that is up to 30%, up to 50% or up to 70% of the distance from the nozzle inlet to the nozzle outlet.

In implementations comprising a plurality of projection portions, the projection portions may be substantially uniform in their shape and dimensions or may be non-uniform in their shape and dimensions, i.e. the shape and dimensions of one or more of the projection portions may differ from the shape and dimensions of at least one of the other projection portions.

One or more of the nozzle bodies may comprise a portion of uniform cross-section, e.g. a cylindrical portion. The portion of uniform cross-section may extend from the nozzle inlet.

One or more of the nozzle bodies may comprise a portion of non-uniform cross-section, e.g. a tapered or conical portion. The portion of non-uniform cross-section may lead to the nozzle outlet.

For example, one or more of the nozzle bodies may comprise a portion of uniform cross-section and a portion of non-uniform cross-section. The portion of non-uniform cross-section may be disposed downstream or upstream of the portion of uniform cross-section.

In implementations comprising a plurality of nozzles, the nozzle bodies may be substantially uniform in their shape and dimensions or may be non-uniform in their shape and dimensions, i.e. the shape and dimensions of one or more of the nozzle bodies may differ from the shape and dimensions of at least one of the other nozzle bodies.

One or more of the nozzle bodies may be formed of one or more nozzle body parts. Any given nozzle body may be formed of any number or combination of nozzle body parts.

In implementations comprising a plurality of nozzles, the nozzle bodies may be substantially uniform in their construction or may be non-uniform in their construction, e.g. one or more of the nozzle bodies may be formed of a different number or combination of nozzle body parts from at least one of the other nozzle bodies.

One or more of the nozzles may be formed at least in part from a flexible material, e.g. a flexible polymeric material.

One or more of the nozzles or one or more of the nozzle body portions may be fixed in place by a nozzle fixing plate.

The nozzle fixing plate may be disposed adjacent an inner surface of the faceplate. The nozzle fixing plate may be disposed between the faceplate and the chamber. The chamber may be disposed between the nozzle fixing plate and the back plate.

The faceplate may comprise any number of apertures therein with a nozzle disposed at least partially in each aperture.

In implementations, one or more enclosure portions may protrude into the chamber from the back plate. A given enclosure portion may surround at least partially one of the projection portions. In an implementation, a given projection portion and a given enclosure portion may be arranged concentrically with each other.

The or each enclosure portion may be configured such that a portion of the nozzle body including the nozzle inlet is surrounded at least partially by the enclosure portion and there is a second gap between the nozzle body and the enclosure portion such that, in use, water can flow from the chamber through the second gap and into the nozzle inlet.

The enclosure portion and the nozzle body together may provide a tortuous, relatively narrow flow path from the chamber through the second gap to the nozzle inlet to reduce or prevent dripping of water from the showerhead occurring at any time when the showerhead is not in operation.

The second gap may be configured such that surface tension of water retained in the second gap when the showerhead is not in operation may be sufficient to limit or prevent dripping of water from occurring at any time when the showerhead is not in operation.

A surface of the nozzle body and/or a surface of the enclosure portion bounding the second gap may be textured and/or roughened. For example, a surface of the nozzle body and/or a surface of the enclosure portion bounding the second gap may have a VDI (Verein Deutscher Ingenieure) 3400 surface finish. As a result of a surface of the nozzle body and/or a surface of the enclosure portion bounding the second gap being textured and/or roughened, surface tension of water retained in the second gap when the showerhead is not in operation may be increased. Accordingly, dripping of water may be less likely to occur at any time when the showerhead is not in operation.

The second gap may have a width of at least 1 mm, at least 2 mm or at least 3 mm. The second gap may have a width of up to 4 mm, up to 5 mm or up to 6 mm.

The second gap may have a length of at least 5 mm or at least 10 mm. The second gap may have a length of up to 12 mm, up to 15 mm, up to 20 mm or up to 30 mm.

A ratio of a width of the second gap to a length of the second gap may be at least 1:2, at least 1:3 or at least 1:4. The ratio of the width of the second gap to the length of the second gap may be up to 1:4, up to 1:5, up to 1:6, up to 1:10 or up to 1:15.

The second gap may have a substantially uniform width along its length. The width of the second gap may be non-uniform along the length of the second gap.

The second gap may have a maximum width of at least 1 mm, at least 2 mm or at least 3 mm. The second gap may have a maximum width of up to 4 mm, up to 5 mm or up to 6 mm.

The second gap may have a maximum length of at least 5 mm or at least 10 mm. The second gap may have a maximum length of up to 12 mm, up to 15 mm, up to 20 mm or up to 30 mm.

A ratio of a maximum width of the second gap to a maximum length of the second gap may be at least 1:2, at least 1:3 or at least 1:4. The ratio of the maximum width of the second gap to the maximum length of the second gap may be up to 1:4, up to 1:5, up to 1:6, up to 1:10 or up to 1:15.

In implementations, the faceplate may have a plurality of apertures therein. Implementations may comprise a plurality of nozzles and a plurality of enclosure portions. The second gaps between the nozzle bodies and the enclosure portions may be substantially uniform in their shape and dimensions or may be non-uniform in their shape and dimensions, i.e. the shape and dimensions of one or more of the second gaps may differ from the shape and dimensions of at least one of the other second gaps.

The chamber may have a height of up to or at least 10 mm, up to or at least 20 mm, up to or at least 30 mm, up to or at least 40 mm, up to or at least 50 mm or up to or at least 60 mm.

One or more of the enclosure portions may protrude into the chamber from the back plate by a distance that is at least 40% of the height of the chamber, at least 50% of the height of the chamber, at least 60% of the height of the chamber, at least 70% of the height of the chamber, at least 80% of the height of the chamber or at least 90% of the height of the chamber.

The height of the chamber may be substantially uniform or may be non-uniform.

The chamber may have a maximum height of up to or at least 10 mm, up to or at least 20 mm, up to or at least 30 mm, up to or at least 40 mm, up to or at least 50 mm or up to or at least 60 mm.

One or more of the enclosure portions may protrude into the chamber from the back plate by a distance that is at least 40% of the maximum height of the chamber, at least 50% of the maximum height of the chamber, at least 60% of the maximum height of the chamber, at least 70% of the maximum height of the chamber, at least 80% of the maximum height of the chamber or at least 90% of the maximum height of the chamber.

One or more of the enclosure portion may protrude into the chamber from the back plate by a distance that is at least 40% of a local height of the chamber, at least 50% of a local height of the chamber, at least 60% of a local height of the chamber, at least 70% of a local height of the chamber, at least 80% of a local height of the chamber or at least 90% of a local height of the chamber.

In implementations comprising a plurality of enclosure portions, the enclosure portions may be substantially uniform in their shape and dimensions or may be non-uniform in their shape and dimensions, i.e. the shape and dimensions of one or more of the enclosure portions may differ from the shape and dimensions of at least one of the other enclosure portions.

A third aspect provides a plumbing or ablutionary system comprising an overhead shower comprising a showerhead according to the present disclosure, wherein the showerhead is in fluid communication with a water supply.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

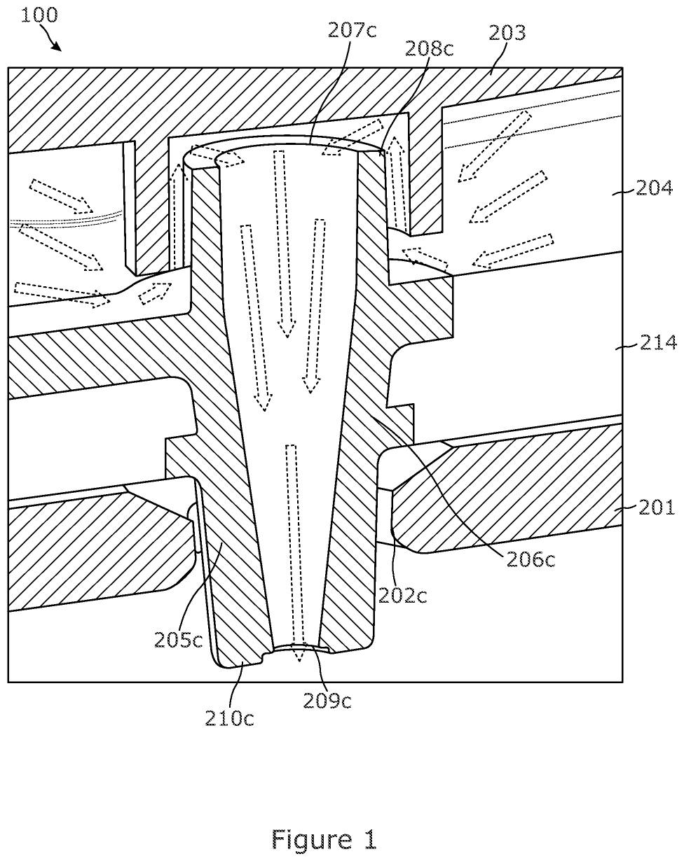

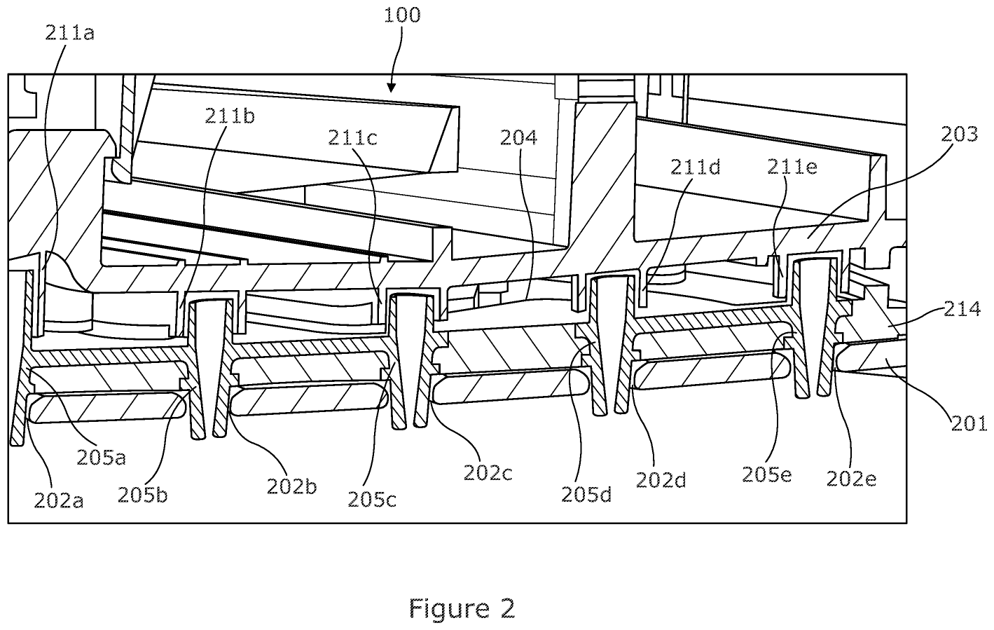

FIGS. 1 and 2 each show a sectional view of a portion of a first example of a showerhead 100 for an overhead shower.

The showerhead 100 comprises a faceplate 201 with a plurality of apertures therein. A chamber 204 is disposed within the showerhead 100.

Five of the apertures 202a, 202b, 202c, 202d, 202e are shown in FIG. 2. One of these apertures 202c is shown in FIG. 1. A nozzle is disposed at least partially in each aperture. As shown in FIG. 2, a nozzle 205a extends through the aperture 202a, a nozzle 205b extends through the aperture 202b, a nozzle 205c extends through the aperture 202c, a nozzle 205d extends through the aperture 202d and a nozzle 205e extends through the aperture 202e. The general configuration of each nozzle 205a, 205b, 205c, 205d, 205e is the same as the other nozzles. Hence, only the nozzle 205c shown in FIG. 1 will be described in particular detail. It will be understood that the description of the nozzle 205c may apply to any one of the other nozzles.

The nozzles 205a, 205b, 205c, 205d, 205e may be formed at least in part from a flexible material, e.g. a flexible polymeric material.

The nozzles 205a, 205b, 205c, 205d, 205e are fixed in position by a nozzle fixing plate 214. The nozzle fixing plate 214 is disposed adjacent an inner surface of the faceplate 201. The nozzle fixing plate 214 is disposed between the faceplate 201 and the chamber 204. The chamber 204 is disposed between the nozzle fixing plate 214 and a back plate 203. The nozzle fixing plate 214 may be relatively rigid compared with the nozzles 205a, 205b, 205c, 205d, 205e.

The nozzle 205c comprises a nozzle body 206c having a nozzle inlet 207c at a first end 208c and a nozzle outlet 209c at a second end 210c. The nozzle inlet 207c is inboard of the faceplate 201 and the nozzle fixing plate 214.

A plurality of enclosure portions protrude into the chamber 204 from the back plate 203. Five of the enclosure portions 211a, 211b, 211c, 211d, 211e are shown in FIG. 2. Each enclosure portion is configured such that a portion of the nozzle body including the nozzle inlet is surrounded by the enclosure portion. The enclosure portions 211a, 211b, 211c, 211d, 211e are configured to surround a portion of the nozzle body including the nozzle inlet of the nozzles 205a, 205b, 205c, 205d, 205e respectively.

For a given nozzle body, there is a gap between the given nozzle body and the enclosure portion surrounding the portion of the given nozzle body such that, in use, water can flow from the chamber 204 though the gap and into the nozzle inlet of the given nozzle body. The enclosure portion and the given nozzle body together provide a tortuous, relatively narrow flow path from the chamber 204 through the gap to the nozzle inlet to help reduce or prevent dripping of water from the showerhead 100 occurring at any time when the showerhead 100 is not in operation.

As can be seen in FIG. 1, the enclosure portion 211c protrudes into the chamber 204 from the back plate 203. The enclosure portion 211c is configured such that a portion of the nozzle body 206c including the nozzle inlet 207c is surrounded by the enclosure portion 211c. There is a gap 213 between the nozzle body 206c and the enclosure portion 211c. As indicated by the block arrows in FIG. 1 water can flow, in use, from the chamber 204, through the gap 213 and into the nozzle inlet 207c. The water then flows along the nozzle 205c and out of the nozzle outlet 209c at the second end 210c of the nozzle body 206c.

The gap 213 provides a tortuous, relatively narrow flow path from the chamber 204 to the nozzle inlet 207c. The tortuous, relatively narrow flow paths form the chamber 204 to each nozzle inlet may provide a labyrinth that helps to retain water within the showerhead 100 when the showerhead 100 is not in operation, thereby limiting or preventing dripping of water from the showerhead 100 occurring at any time when the showerhead 100 is not in operation. This may also help to enable the use of relatively larger diameter nozzles in the showerhead 100.

The gap 213 is configured such that surface tension of water retained in the gap 213 when the showerhead 100 is not in operation may be sufficient to limit or prevent dripping of water from occurring at any time when the showerhead 100 is not in operation.

A surface of the nozzle body 206c and/or a surface of the enclosure portion 211c bounding the gap 213 may be textured and/or roughened. For example, a surface of the nozzle body 206c and/or a surface of the enclosure portion 211c bounding the gap 213 may have a VDI (Verein Deutscher Ingenieure) 3400 surface finish. As a result of a surface of the nozzle body 206c and/or a surface of the enclosure portion 211c bounding the gap 213 being textured and/or roughened, surface tension of water retained in the gap 213 when the showerhead 100 is not in operation may be increased. Accordingly, dripping of water may be less likely to occur at any time when the showerhead 100 is not in operation.

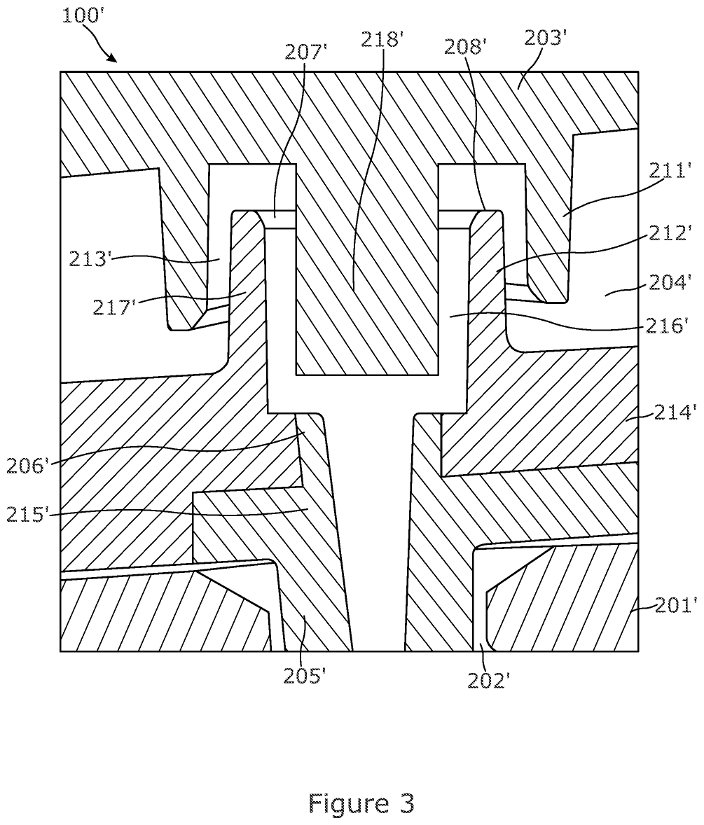

FIG. 3 shows a sectional view of a portion of a second example of a showerhead 100′ for an overhead shower.

The showerhead 100′ comprises a faceplate 201′ with a plurality of apertures therein. A chamber 204′ is disposed within the showerhead 100′.

One of these apertures 202′ in the faceplate 201′ is shown in FIG. 3.

A nozzle 205′ extends through the aperture 202′.

An outlet portion 215′ of the nozzle 205′ is fixed in position by a nozzle fixing plate 214′. The nozzle fixing plate 214′ is disposed in part adjacent an inner surface of the faceplate 201′. The nozzle fixing plate 214′ is disposed between the faceplate 201′ and the chamber 204′. The chamber 204′ is disposed between the nozzle fixing plate 214′ and a back plate 203′.

The outlet portion 215′ of the nozzle 205′ may be formed at least in part from a flexible material, e.g. a flexible polymeric material. The nozzle fixing plate 214′ may be relatively rigid compared with the outlet portion 215′ of the nozzle 205′.

The nozzle 205′ also includes an inlet portion 217′. The inlet portion 217′ of the nozzle 205′ comprises a tubular portion 212′ of the nozzle fixing plate 214′ that extends in a direction towards the back plate 203′.

The nozzle 205′ comprises a nozzle body 206′ having a nozzle inlet 207′ at a first end 208′ and a nozzle outlet (not shown) at a second end (not shown). The nozzle inlet 207′ is inboard of the faceplate 201′. In this example implementation, the nozzle body 206′ is made up of two nozzle body parts: the inlet portion 217′ and the outlet portion 215′. In other implementations, the nozzle body 206′ may be formed from a single nozzle body part, e.g. as shown in FIGS. 1 and 2 and discussed above.

An enclosure portion 211′ protrudes into the chamber 204′ from the back plate 203′. The enclosure portion 211′ is configured such that a portion of the nozzle body 206′ including the nozzle inlet 207′ is surrounded by the enclosure portion 211′.

There is a first gap 213′ between the inlet portion 217′ of the nozzle body 206′ and the enclosure portion 211′ such that, in use, water can flow from the chamber 204′ through the first gap 213′ and into the nozzle inlet 207′. The enclosure portion 211′ and the inlet portion 217′ of the nozzle body 206′ together provide a tortuous, relatively narrow flow path from the chamber 204′ through the first gap 213′ to the nozzle inlet 207′ to help reduce or prevent dripping of water from the showerhead 100′ occurring at any time when the showerhead 100′ is not in operation.

A projection portion 218′ protrudes from the back plate 203′. The projection portion 218′ is disposed inside the enclosure portion 211′. For example, the projection portion 218′ may be generally cylindrical in form. The projection portion 218′ and the enclosure portion 211′ may be arranged concentrically with each other.

The projection portion 218′ extends a distance into the inlet portion 217′ of the nozzle body 206′. There is a second gap 216′ between the projection portion 218′ and the inlet portion 217′ through which water flows, in use, after passing through the nozzle inlet 207′. In the illustrated example, the second gap 216′ is an annular gap between the projection portion 218′ and the inlet portion 217′. In the illustrated example, the projection portion 218′ does not extend as far as the outlet portion 215′ of the nozzle body 206′. After passing through the second gap 216′, water flows, in use, through the outlet portion 215′ of the nozzle body 206′ and out of the nozzle outlet. The projection portion 218′ and the inlet portion 217′ of the nozzle body 206′ together provide a relatively narrow flow path within the inlet portion 217′, which helps to reduce or prevent dripping of water from the showerhead 100′ occurring at any time when the showerhead 100′ is not in operation.

A tortuous, relatively narrow flow path from the chamber 204′ to the outlet portion 215′ of the nozzle body 206′ comprises the first gap 213′ and the second gap 216′. The tortuous, relatively narrow flow paths form the chamber 204′ to the outlet portion of each nozzle body may provide a labyrinth that helps to retain water within the showerhead 100′ when the showerhead 100′ is not in operation, thereby limiting or preventing dripping of water from the showerhead 100′ occurring at any time when the showerhead 100′ is not in operation. This may also help to enable the use of relatively larger diameter nozzles in the showerhead 100′.

The first gap 213′ is configured such that surface tension of water retained in the first gap 213′ when the showerhead 100′ is not in operation may be sufficient to limit or prevent dripping of water from occurring at any time when the showerhead 100′ is not in operation.

A surface of the nozzle body 206′ and/or a surface of the enclosure portion 211′ bounding the first gap 213′ may be textured and/or roughened. For example, a surface of the nozzle body 206′ and/or a surface of the enclosure portion 211′ bounding the first gap 213′ may have a VDI (Verein Deutscher Ingenieure) 3400 surface finish. As a result of a surface of the nozzle body 206′ and/or a surface of the enclosure portion 211′ bounding the first gap 213′ being textured and/or roughened, surface tension of water retained in the first gap 213′ when the showerhead 100′ is not in operation may be increased. Accordingly, dripping of water may be less likely to occur at any time when the showerhead 100′ is not in operation.

The second gap 216′ is configured such that surface tension of water retained in the second gap 216′ when the showerhead 100′ is not in operation may be sufficient to limit or prevent dripping of water from occurring at any time when the showerhead 100′ is not in operation.

A surface of the inlet portion 217′ and/or a surface of the projection portion 218′ bounding the second gap 216′ may be textured and/or roughened. For example, a surface of the inlet portion 217′ and/or a surface of the projection portion 218′ bounding the second gap 216′ may have a VDI (Verein Deutscher Ingenieure) 3400 surface finish. As a result of a surface of the inlet portion 217′ and/or a surface of the projection portion 218′ bounding the second gap 216′ being textured and/or roughened, surface tension of water retained in the second gap 216′ when the showerhead 100′ is not in operation may be increased. Accordingly, dripping of water may be less likely to occur at any time when the showerhead 100′ is not in operation.

In some implementations, only one of the first gap 213′ and the second gap 216′ may be present.

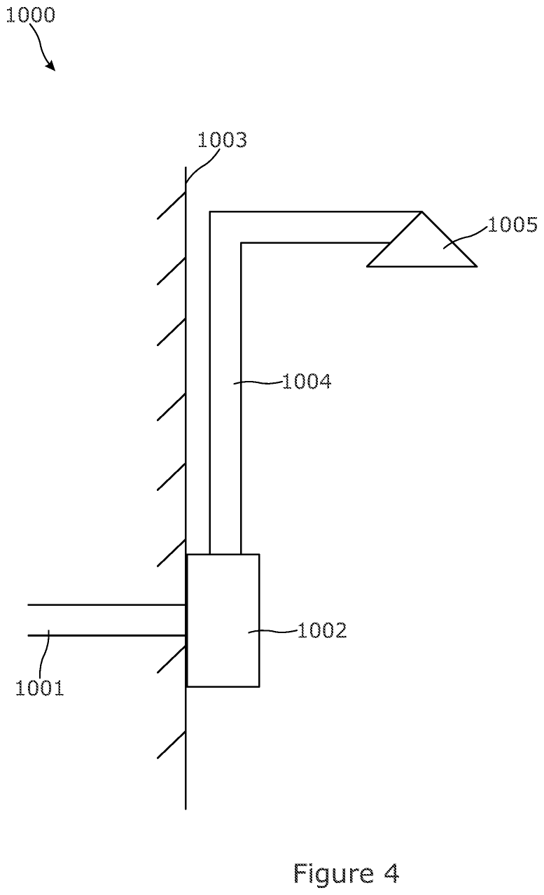

FIG. 4 shows schematically an example of an ablutionary system in the form of a shower system 1000. The shower system 1000 is an electric shower system.

A water supply pipe 1001 is configured to convey water from a water source (not shown) to an electric shower unit 1002 mounted on a wall 1003. The electric shower unit 1002 comprises an instantaneous water heater comprising one or more electrical heating elements operable to heat water flowing through a heater tank in the electric shower unit 1002 to provide a stream of water having a user-desired temperature. The stream of water having a user-desired temperature is conveyed along a connecting pipe 1004 from the electric shower unit 1002 to an overhead shower 1005. The overhead shower 1005 comprises a showerhead according to the present disclosure. For example, the overhead shower 1005 may comprise the showerhead 100 of FIGS. 1 and 2 or the showerhead 100′ of FIG. 3.

It will be appreciated that the shower system 1000 is simply an example of an ablutionary or plumbing system that may comprise a showerhead according to the present disclosure. For instance, in any plumbing or ablutionary system comprising an overhead shower, the overhead shower may comprise a showerhead according to the present disclosure.

The shower system may comprise a non-electric instantaneous water heater.

In another implementation, the shower system may comprise a mixer valve. The mixer valve may be connected to a first water supply pipe, the first water supply pipe being configured to convey cold water from a water source to the mixer valve, and a second water supply pipe, the second water supply pipe being configured to convey hot water from a water source to the mixer valve. The mixer valve may be operable to provide a stream of water having a user-desired temperature by mixing cold water and hot water in the required proportions.

As used herein, the term relatively narrow may be understood to mean a local constriction, i.e. a reduction in cross-sectional area, in a flow path that would not otherwise be present compared with a situation in which the enclosure portion(s) and/or the projection portion(s) and the nozzle body(ies) were not present and arranged in accordance with this disclosure.

It will be understood that the invention is not limited to the embodiments described above. Various modifications and improvements can be made without departing from the concepts disclosed herein. Except where mutually exclusive, any of the features may be employed separately or in combination with any other features and the disclosure extends to all combinations and sub-combinations of one or more features disclosed herein.

1. A showerhead comprising:
a faceplate with one or more apertures therein;
a chamber disposed within the showerhead, the chamber in fluid communication, in use, with a water supply;
a nozzle disposed at least partially in each aperture, one or more of the nozzles comprising a nozzle body having a nozzle inlet at a first end and a nozzle outlet at a second end, wherein the nozzle inlet is inboard of the faceplate;
one or more enclosure portions protruding into the chamber from a back plate, wherein a portion of the nozzle body including the nozzle inlet is surrounded at least partially by the enclosure portion, and there is a first gap between the nozzle body and the enclosure portion such that, in use, water flows from the chamber through the first gap and into the nozzle inlet;
wherein the enclosure portion and the nozzle body together provide a tortuous, relatively narrow flow path from the chamber through the first gap to the nozzle inlet to reduce or prevent dripping of water from the showerhead occurring at any time when the showerhead is not in operation.

2. The showerhead of claim 1, wherein surface tension of water retained in the first gap when the showerhead is not in operation is sufficient to limit or prevent dripping of water from occurring at any time when the showerhead is not in operation.

3. The showerhead of claim 1, wherein a surface of the nozzle body and/or a surface of the enclosure portion bounding the first gap is textured and/or roughened.

4. The showerhead of claim 1, wherein the first gap has a maximum width of at least 1 mm and/or up to 6 mm.

5. The showerhead of claim 1, wherein the first gap has a maximum length of at least 5 mm and/or up to 30 mm.

6. The showerhead of claim 1, wherein a ratio of a maximum width of the first gap to a maximum length of the first gap is at least 1:2 and/or up to 1:15.

7. The showerhead of claim 1, wherein the enclosure portion protrudes into the chamber from the back plate by a distance that is at least 40% of a local height of the chamber.

8. A showerhead comprising:
a faceplate with one or more apertures therein;
a chamber disposed within the showerhead, the chamber in fluid communication, in use, with a water supply;
a nozzle disposed at least partially in each aperture, one or more of the nozzles comprising a nozzle body having a nozzle inlet at a first end and a nozzle outlet at a second end, wherein the nozzle inlet is inboard of the faceplate;
one or more enclosure portions protruding into the chamber from a back plate, wherein a portion of the nozzle body including the nozzle inlet is surrounded at least partially by the enclosure portion, and there is a first gap between the nozzle body and the enclosure portion such that, in use, water flows from the chamber through the first gap and into the nozzle inlet;
wherein the enclosure portion and the nozzle body together provide a tortuous, relatively narrow flow path from the chamber through the first gap to the nozzle inlet to reduce or prevent dripping of water from the showerhead occurring at any time when the showerhead is not in operation;
wherein one of more projection portions protrude from the back plate, each projection portion extends a distance beyond the nozzle inlet into the nozzle body of one of the nozzles such that, in use, water flows through a second gap between the projection portion and the nozzle body or a portion thereof after passing through the nozzle inlet.

9. The showerhead of claim 8, wherein surface tension of water retained in the second gap when the showerhead is not in operation is sufficient to limit or prevent dripping of water from occurring at any time when the showerhead is not in operation.

10. The showerhead of claim 8, wherein a surface of the nozzle body and/or a surface of the projection portion bounding the second gap is textured and/or roughened.

11. The showerhead of claim 8, wherein a tortuous, relatively narrow flow path from the chamber to within the nozzle comprises the first gap and the second gap.

12. The showerhead of claim 11, wherein, for a given tortuous, relatively narrow flow path from the chamber to within a given nozzle, the second gap has the same width or the same maximum width as the first gap or the second gap is wider than or narrower than the first gap.

13. The showerhead of claim 11, wherein the second gap is shorter than, longer than or has substantially the same length as the first gap.

14. The showerhead of claim 8, wherein the second gap has a maximum width of at least 1 mm and/or up to 6 mm.

15. The showerhead of claim 8, wherein the second gap has a maximum length of at least 5 mm and/or up to 30 mm.

16. The showerhead of claim 8, wherein a ratio of a maximum width of the second gap to a maximum length of the second gap is at least 1:2 and/or up to 1:15.

17. The showerhead of claim 8, wherein each projection portion protrudes from the back plate by a distance beyond the nozzle inlet into the nozzle body that is at least 5% of a distance from the nozzle inlet to the nozzle outlet and/or each projection portion protrudes from the back plate by a distance beyond the nozzle inlet into the nozzle body that is up to 70% of the distance from the nozzle inlet to the nozzle outlet.

18. The showerhead of claim 1, wherein one or more of the nozzle bodies comprise a portion of uniform cross-section and/or wherein one or more of the nozzle bodies comprise a portion of non-uniform cross-section.

19. The showerhead of claim 1, wherein one or more of the nozzles or one or more nozzle body portions is/are fixed in place by a nozzle fixing plate.

20. A showerhead for an overhead shower comprising:
a faceplate with one or more apertures therein;
a chamber disposed within the showerhead, the chamber being in fluid communication, in use, with a water supply;
a nozzle disposed at least partially in each aperture, one or more of the nozzles comprising a nozzle body having a nozzle inlet at a first end and a nozzle outlet at a second end, wherein the nozzle inlet is inboard of the faceplate;
one or more projection portions protruding from a back plate and extending a distance beyond the nozzle inlet into the nozzle body such that, in use, water flows through a first gap between the projection portion and the nozzle body or a portion thereof after passing through the nozzle inlet;
wherein the first gap provides a relatively narrow flow path within the nozzle body to help reduce or prevent dripping of water from the showerhead occurring at any time when the showerhead is not in operation.
